(19) United States
(12) Patent Application Publication
(10) Pub. No.: US 2023/0417090 A1
(43) Pub. Date: Dec. 28, 2023

(54) DOOR HANDLE ASSEMBLY FOR A VEHICLE DOOR

(71) Applicant: U-Shin Italia S.p.A., Pianezza (IT)

(72) Inventors: Anthony GUERIN, Pianezza (IT); Antonio ROCCI, Pianezza (IT)

(73) Assignee: U-Shin Italia S.p.A., Pianezza (IT)

(21) Appl. No.: 18/343,247

(22) Filed: Jun. 28, 2023

(30) Foreign Application Priority Data
Jun. 28, 2022 (EP) 22181678.8

(51) Int. Cl. E05B 85/10; E05B 81/76

(52) U.S. Cl. CPC E05B 85/107; E05B 81/77; E05B 85/103

(57) ABSTRACT

A handle assembly for a vehicle door includes a flush handle including a grip member and an actuator. The grip member is configured to cooperate with a latch mechanism to unlatch the door. The grip member is rotatable about a horizontal axis. The actuator is configured to move the grip member from a flush position to a deployed position. In the flush position, the grip member extends flush to an external panel of the door. In the deployed position, the grip member projects with respect to the external panel of the vehicle door. The grip member is manually movable about the horizontal axis from the flush position to a retracted position in which the grip member is retracted inside a recess of the vehicle door. The flush handle further includes a deployment device configured to permit the grip member to automatically move from the retracted position to the deployed position.

### CROSS-REFERENCE TO RELATED APPLICATIONS

This application claims priority to and the benefit of EP 22181678.8 filed on Jun. 28, 2022. The disclosures of the above applications are incorporated herein by reference.

### FIELD

The present disclosure relates to a door handle assembly for a vehicle door, the door handle assembly including a motorized flush handle, and more precisely a horizontal axis motorized flush handle, as well as an automotive vehicle including such a door handle assembly.

### BACKGROUND

The statements in this section merely provide background information related to the present disclosure and may not constitute prior art.

Handle assemblies for vehicle doors generally include a handle, a bracket to which the handle is secured and a mechanical and/or electronic device configured to unlock the vehicle door and to activate a latch to open the vehicle door.

Handles for vehicle doors are components having a significant influence on the style of vehicles.

In this respect, vehicle manufacturers often seek to arrange the handle in the plane of the vehicle door so that it occupies a flush position also called a flush arrangement. A flush handle generally renders the handle as invisible as possible. Moreover, flush handles have the advantage of reducing the aerodynamic noise caused by the rush of air as the vehicle is being driven along.

A flush handle generally includes a grip member configured to cooperate with a latch mechanism so as to unlatch the vehicle door. The grip member is movable between a flush position in which it extends flush to an external panel of the vehicle door, a deployed position in which it projects with respect to the external panel and becomes graspable, and an open position in which it cooperates with the latch mechanism to unlatch the vehicle door.

The grip member is generally connected to an actuator configured to urge the grip member in the deployed position via an actuator lever so that a user can grasp the grip member to open the vehicle door. This type of flush handle is called a motorized flush handle.

Today motorized flush handles are becoming more and more well-known on the market. There are different types of motorized flush handles, with different kinematics: vertical axis motorized flush handles, and horizontal axis motorized flush handles. The term vertical refers to the direction perpendicular to the longitudinal direction of the vehicle and the term horizontal refers to the direction parallel to the longitudinal direction of the vehicle.

A vertical axis motorized flush handle includes a grip member rotatable about a vertical axis to open the vehicle door. To move from the flush position to the deployed position, the grip member is translatable towards the outside of the vehicle, or rotatable about the vertical axis towards the outside of the vehicle.

A horizontal axis motorized flush handle includes a grip member rotatable about a horizontal axis to open the vehicle door. In this configuration, the grip member is rotatable about the horizontal axis towards the outside of the vehicle, to move from the flush position to the deployed position.

Some motorized flush handles are generally not satisfactory because, in case of battery malfunction, there is no possibility of deploying the grip member.

It therefore appears that, from several standpoints, there is room for improvement in horizontal axis motorized flush handle for vehicle doors. The teachings of the present disclosure address these and other issues with horizontal axis motorized flush handles.

### SUMMARY

This section provides a general summary of the disclosure and is not a comprehensive disclosure of its full scope or all of its features.

According to one form of the present disclosure, a handle assembly for a vehicle door includes a flush handle including a grip member and an actuator. The grip member is configured to cooperate with a latch mechanism to unlatch the vehicle door. The grip member is rotatable about a horizontal axis. The actuator is configured to move the grip member from a flush position to a deployed position. In the flush position, the grip member extends flush to an external panel of the vehicle door. In the deployed position, the grip member projects with respect to the external panel of the vehicle door. The grip member is manually movable about the horizontal axis from the flush position to a retracted position in which the grip member is retracted inside a recess of the vehicle door. The flush handle further includes a deployment device configured to permit the grip member to automatically move from the retracted position to the deployed position.

According to variations of this handle assembly, which may be employed individually or in any combination: the flush handle includes an actuator lever connecting the actuator to the grip member; in the retracted position, the grip member is configured to be disconnected from the actuator lever; the actuator lever is rotatable about an actuator lever axis, the actuator lever axis being parallel to and below the horizontal axis and located closer to inside the automotive vehicle than the horizontal axis; the deployment device includes at least one deployment spring; the handle assembly includes an electronic device permitting cooperation of the grip member with the latch mechanism; the electronic device includes a sensor located on the grip member, the sensor being configured to be accessible to a user when the grip member is in the deployed position and not accessible to the user when the grip member is in the flush position; the grip member is manually movable about the horizontal axis towards an outside of the vehicle door, from the deployed position to an open position, and the electronic device includes a switch configured to be activated when the grip member is in the open position.

According to another form of the present disclosure, an automotive vehicle includes a vehicle door including a handle assembly. The handle assembly includes a flush handle including a grip member and an actuator. The grip member is configured to cooperate with a latch mechanism to unlatch the vehicle door. The grip member is rotatable about a horizontal axis. The actuator is configured to move the grip member from a flush position to a deployed position. In the flush position, the grip member extends flush to an external panel of the vehicle door. In the deployed position, the grip member projects with respect to the external panel of the vehicle door. The grip member is manually movable about the horizontal axis from the flush position to a retracted position in which the grip member is retracted inside a recess of the vehicle door. The flush handle further includes a deployment device configured to permit the grip member to automatically move from the retracted position to the deployed position.

According to variations of this automotive vehicle, which may be employed individually or in any combination: the flush handle includes an actuator lever connecting the actuator to the grip member; in the retracted position, the grip member is configured to be disconnected from the actuator lever; the actuator lever is rotatable about an actuator lever axis, the actuator lever axis being parallel to and below the horizontal axis and located closer to inside the automotive vehicle than the horizontal axis; the deployment device includes at least one deployment spring; the handle assembly includes an electronic device permitting cooperation of the grip member with the latch mechanism; the electronic device includes a sensor located on the grip member, the sensor being configured to be accessible to a user when the grip member is in the deployed position and not accessible to the user when the grip member is in the flush position; the grip member is manually movable about the horizontal axis towards an outside of the vehicle door, from the deployed position to an open position, and the electronic device includes a switch configured to be activated when the grip member is in the open position.

The handle assembly according to the present disclosure provides a backup mechanism allowing the grip member to be manually moved in case of battery failure of the actuator.

Thus, the safety of the handle assembly is improved.

The handle assembly can include the following features, considered alone or in any technically possible combination:
the flush handle can include an actuator lever connecting the actuator to the grip member;
in retracted position, the grip member can be configured to be disconnected from the actuator lever;
the actuator lever can be rotatable about an actuator lever axis, the actuator lever axis being parallel to and below the horizontal axis and located closer to inside the automotive vehicle than the horizontal axis;
the deployment device can include at least one deployment spring;
the handle assembly can include an electronic device permitting cooperation of the grip member with the latch mechanism;
the electronic device can include a sensor located on the grip member, the sensor being configured to be accessible to a user when the grip member is in the deployed position and not accessible to the user when the grip member is in the flush position;
the grip member can be manually movable about the horizontal axis towards the outside of the vehicle door, from the deployed position to an open position, and the electronic device can include a switch configured to be activated when the grip member is in the open position.

According to a further aspect, the present disclosure concerns an automotive vehicle including a vehicle door including a handle assembly as described above.

Further advantages and areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

In the following description, the terms “front view” and “rear view” refer to a user looking at the vehicle door from outside the vehicle;

FIG. 1 is a perspective front view of a handle assembly according to one form of the present disclosure, for a vehicle door;

FIG. 2 is a perspective rear view of a flush handle of the handle assembly of FIG. 1, the flush handle including a grip member illustrated in a flush position in accordance with the teachings of the present disclosure;

FIG. 3 is a perspective rear view of the flush handle FIG. 2, the grip member being illustrated in a deployed position in accordance with the teachings of the present disclosure;

FIG. 4 is a side section view of the flush handle of FIG. 3 showing an example of electronic device configured to unlatch the vehicle door in accordance with the teachings of the present disclosure;

FIG. 5 is a side section view of the flush handle of FIG. 3, showing another example of electronic device configured to unlatch the vehicle door in accordance with the present disclosure;

FIG. 6 is a schematic cross-sectional view of the handle assembly of FIG. 1, illustrating operation of a backup mechanism allowing the grip member to be manually moved in case of battery failure of the actuator in accordance with the teachings of the present disclosure;

FIG. 7 is a side view of an automotive vehicle including a handle assembly according to FIG. 1, in accordance with the teachings of the present disclosure; and

FIG. 8 is a perspective view of a backup mechanism of a flush handle assembly according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

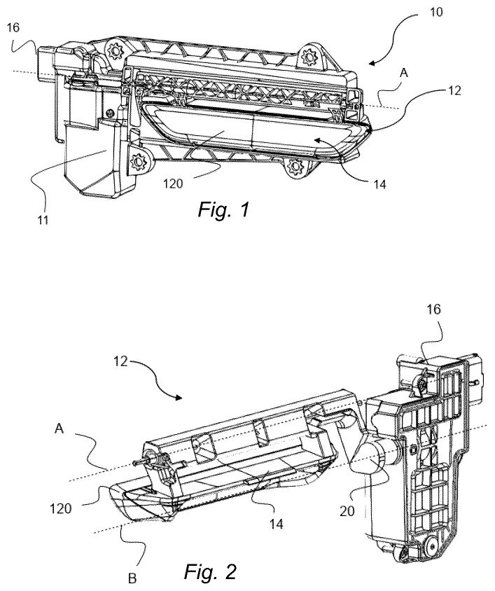

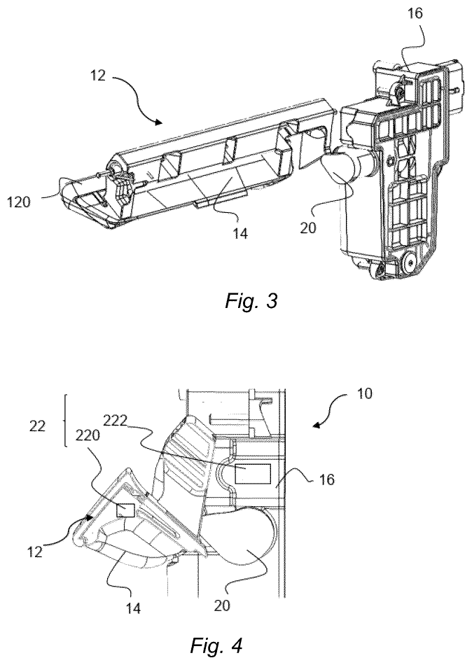

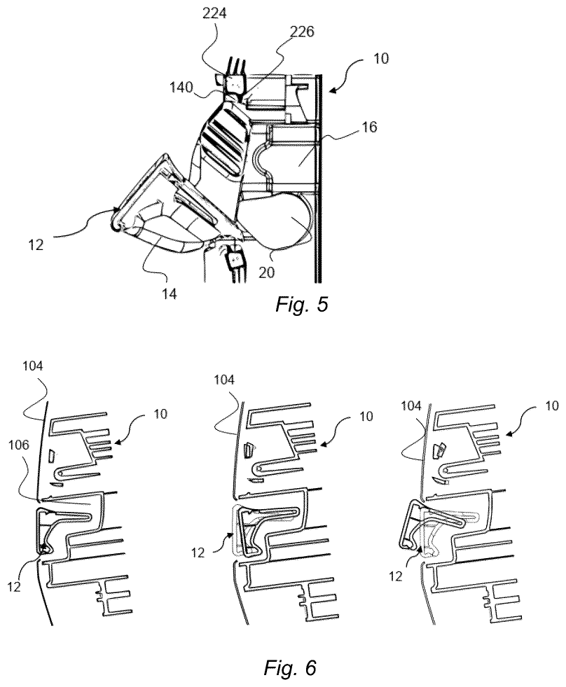

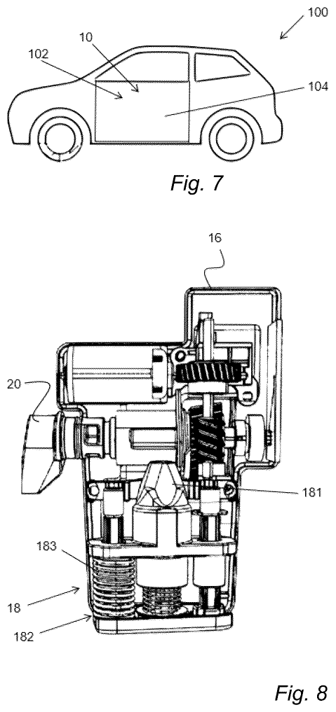

FIGS. 1 to 5 illustrate a handle assembly 10 for a vehicle door 102 (FIG. 7) of an automotive vehicle 100 (FIG. 7).

The handle assembly 10 includes a flush handle 12 movable between a flush position in which it extends flush to an external panel 104 (FIG. 7) of the vehicle door 102 and a deployed position in which it projects with respect to the external panel and becomes graspable.

The flush handle 12 may further be movable to an open position in which it cooperates with a latch mechanism (not represented) to unlatch the vehicle door 102.

The handle assembly 10 can include a bracket 11 configured to house the flush handle 12.

The flush handle 12 includes a grip member 14. More precisely, the grip member 14 is configured to cooperate with the latch mechanism to unlatch the vehicle door 102. Moreover, the grip member 14 is movable between the flush position and the deployed position. The grip member 14 is configured to be graspable in the deployed position. The grip member 14 is rotatable about a horizontal axis A. The term horizontal means parallel to the longitudinal direction of the automotive vehicle 100.

The horizontal axis A can be located at a distance range of 10 to 14 mm from the external panel 104 of the vehicle door 102.

The flush handle 12 includes an actuator 16 configured to move the grip member 14 from the flush position to the deployed position.

As illustrated more particularly in FIG. 8, the flush handle 12 includes a backup mechanism 18 allowing the grip member 14 to be manually moved in case of battery failure of the actuator 16. To this end, the grip member 14 is manually movable about the horizontal axis A. More precisely the grip member 14 is manually movable about the horizontal axis A from the flush position (first cutaway of FIG. 6) to a retracted position (second cutaway of FIG. 6) in which the grip member 14 is retracted inside a recess 106 (FIG. 6) of the vehicle door 102. To this end, a user can push the grip member 14 inwards with respect to the external panel 104 as in the second cutaway of FIG. 6, by applying inwards directed pressure on the grip member 14.

The backup mechanism 18 includes a deployment device 181 configured to allow the grip member 14 to automatically move from the retracted position to the deployed position (third cutaway of FIG. 6). The deployment device 181 can include a push-push unit 182. The push-push unit 182 can include at least one deployment spring 183 configured to drive the grip member 14 in deployed position without actuation of the actuator 16. More precisely, in the retracted position, a mechanical interaction (e.g., a “click”) can release the at least one deployment spring 183 of the push-push unit 182, and the at least one deployment spring 183 can drive the grip member 14 in deployed position without actuation of the actuator 16.

The flush handle 12 includes the deployment device 181.

The push-push unit 182 can include the features as described in document EP 3 421 702, which is incorporated by reference herein in its entirety.

The grip member 12 can include a cover 120. For example, the cover 120 can be configured to be flush with the external panel 104 of the vehicle door 102 when the grip member 14 is in the flush position.

The flush handle 12 can include an actuator lever 20 connecting the actuator 16 to the grip member 14. The actuator lever 20 can be rotatable about an actuator lever axis B. The actuator lever axis B can be parallel to the horizontal axis A. The actuator lever axis B can be below the horizontal axis A. The actuator lever axis B can be located closer to inside the automotive vehicle 100 than the horizontal axis A.

The handle assembly 10 can include an electronic device 22 enabling cooperation of the grip member 14 with the latch mechanism (not represented). The flush handle 12 is therefore an electronic flush handle.

The electronic device 22 can include a sensor 220. The sensor 220 can be located on the grip member 14. The sensor 220 can be configured to be accessible to a user when the grip member 14 is in the deployed position and not accessible to the user when the grip member 14 is in the flush position. The electronic device 22 can include an electronic control unit 222 configured to receive a signal from the sensor 220 and to send the signal to the latch mechanism to unlatch the vehicle door. The sensor 220 can be a capacitive sensor or a inductive sensor.

The flush handle 12 can include a lighting device (not represented) configured to light up when the sensor 220 is activated.

The grip member 14 can be manually movable about the horizontal axis A towards the outside of the vehicle door 102, from the deployed position to the open position. The electronic device 22 can include a switch 224 configured to be activated when the grip member 14 is in the open position. For example the switch 224 can be activated when the grip member 14 forms an angle included between 2° and 20°, in one form between 2° and 10°, in another form between 2° to 8°, relative to the flush position. The switch 224 includes an actuating element 226 projecting into the path of the grip member 14 from the deployed position to the open position. The actuating element 226 can cooperate with, for example, a control element 140 on the grip member 14. The switch 224 and the control element 140 are components of the electrical device 22, which acts on the latch mechanism.

The flush handle 12 can include a return device (not represented) allowing the grip member 14 to move from the open position to the deployed position. The return device can be a return spring (not represented).

FIG. 6 illustrates operation of the backup mechanism 18 allowing the grip member 14 to be manually moved in case of battery failure of the actuator 16.

A user pushes on the grip member 14 in order to move the grip member 14 about the horizontal axis A inside the recess 106 of the vehicle door 102. The grip member 14 moves from the flush position to the retracted position.

In the retracted position, the deployment device 181 allows the grip member 14 to automatically move from the retracted position to the deployed position.

FIG. 7 illustrates an automotive vehicle 100 including a vehicle door 102 including a handle assembly 10 as described above.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A handle assembly for a vehicle door, the handle assembly comprising:
a flush handle comprising:
a grip member configured to cooperate with a latch mechanism to unlatch the vehicle door, the grip member being rotatable about a horizontal axis; and
an actuator configured to move the grip member from a flush position to a deployed position, wherein in the flush position the grip member extends flush to an external panel of the vehicle door, wherein in the deployed position the grip member projects with respect to the external panel of the vehicle door,
wherein the grip member is manually movable about the horizontal axis from the flush position to a retracted position in which the grip member is retracted inside a recess of the vehicle door,
wherein the flush handle further comprises a deployment device configured to permit the grip member to automatically move from the retracted position to the deployed position.

2. The handle assembly according to claim 1, wherein the flush handle comprises an actuator lever connecting the actuator to the grip member.

3. The handle assembly according to claim 2, wherein in the retracted position, the grip member is configured to be disconnected from the actuator lever.

4. The handle assembly according to claim 3, wherein the actuator lever is rotatable about an actuator lever axis, the actuator lever axis being parallel to and below the horizontal axis and located closer to inside the automotive vehicle than the horizontal axis.

5. The handle assembly according to claim 2, wherein the actuator lever is rotatable about an actuator lever axis, the actuator lever axis being parallel to and below the horizontal axis and located closer to inside the automotive vehicle than the horizontal axis.

6. The handle assembly according to claim 1, wherein the deployment device comprises at least one deployment spring.

7. The handle assembly according to claim 1, wherein the handle assembly comprises an electronic device permitting cooperation of the grip member with the latch mechanism.

8. The handle assembly according to claim 7, wherein the electronic device comprises a sensor located on the grip member, the sensor being configured to be accessible to a user when the grip member is in the deployed position and not accessible to the user when the grip member is in the flush position.

9. The handle assembly according to claim 7, wherein the grip member is manually movable about the horizontal axis towards an outside of the vehicle door, from the deployed position to an open position, and the electronic device comprises a switch configured to be activated when the grip member is in the open position.

10. An automotive vehicle comprising a vehicle door comprising the handle assembly according to claim 1.
